(19) United States
(12) Patent Application Publication
(10) Pub. No.: US 2006/0278293 A1
(43) Pub. Date: Dec. 14, 2006

(54) PRESSURE MEASURING LINE, PARTICULARLY FOR INVASIVE BLOOD PRESSURE MEASUREMENT

(75) Inventors: Jorg Weber, Edling (DE); Bernd Beck, Rangendingen (DE)

Correspondence Address: SENNIGER POWERS, ONE METROPOLITAN SQUARE, 16TH FLOOR, ST LOUIS, MO, 63102, US

(73) Assignee: SMITHS MEDICAL DEUTSCHLAND GMBH, Kirchseeon (DE)

(21) Appl. No.: 11/423,858

(22) Filed: Jun. 13, 2006

(30) Foreign Application Priority Data
Jun. 13, 2005 (DE) 20 2005 009 293.2

(51) Int. Cl. F16L 9/14

(52) U.S. Cl. 138/140; 138/137; 138/141; 138/114

(57) ABSTRACT

The invention relates to a pressure measuring line, particularly for invasive blood pressure measurement, which presents a wall made of a flexible material, which surrounds a passageway. The wall consists particularly of at least one inner hose and an outer hose enveloping the former, where the material of the inner hose is harder than the material of the outer hose, and the wall thickness of the inner hose is less than the wall thickness of the outer hose. The inner side of the outer hose is in full-surface contact with the outer side of the inner hose.

### CROSS REFERENCE TO RELATED APPLICATIONS

This application claims priority from DE patent application number 20 2005 009 293.2 filed Jun. 13, 2005, the entire disclosure of which is herein incorporated by reference.

### BACKGROUND OF THE INVENTION

The invention relates to a pressure measuring line, particularly for invasive blood pressure measurement according to the preamble of claim 1.

In invasive blood pressure measurement, a pressure measuring transducer is connected by a hose-like pressure measuring line to an artery or a vein of a patient (see DE 44 00 941 C1). The pressure measuring transducer generates an electrical output signal, which corresponds to the blood pressure to be measured. This signal is usually displayed on a monitor. In the process, a liquid-filled transmission system is provided, which periodically receives the impact of the blood pressure of the patient. This transmission system transmits the pressure variation of the blood pressure to the pressure measuring transducer, where the temporal pattern of the pressure provides important information to the physician.

To what extent the final signal displayed on the monitor actually corresponds to the pattern of the blood pressure it is problematic. A significant source of error can be the pressure measuring line which, as a function of its intrinsic or resonance frequency and damping can bias or falsify the pressure pattern to varying degrees.

To date, flexible hoses have been used for the pressure measuring line, which, although they have the advantage of simple handling and positioning, nevertheless, due to their flexibility, lead to a reduction of the resonance frequency and thus to a larger transmission error.

The problem of the invention is to produce a pressure measuring line which, while being easy to handle, produces no biasing or only slight biasing of the measurement result.

### SUMMARY OF THE INVENTION

Briefly, therefore, the invention is directed to pressure measuring line for invasive blood pressure measurement comprising a wall made of a flexible material that surrounds a passageway, wherein the wall comprises at least one inner hose and an outer hose enveloping the inner hose, wherein the material of the inner hose is harder than the material of the outer hose, the wall thickness of the inner hose is less than the wall thickness of the outer hose, and the inner surface of the outer hose is in full-surface contact with the outer surface of the inner hose.

Other objects and features are in part apparent and in part pointed out hereinafter.

### BRIEF DESCRIPTION OF THE DRAWINGS

FIG. 1 shows a cross section through the pressure measuring line; and

FIG. 2 shows a portion of the pressure-measuring line in longitudinal section.

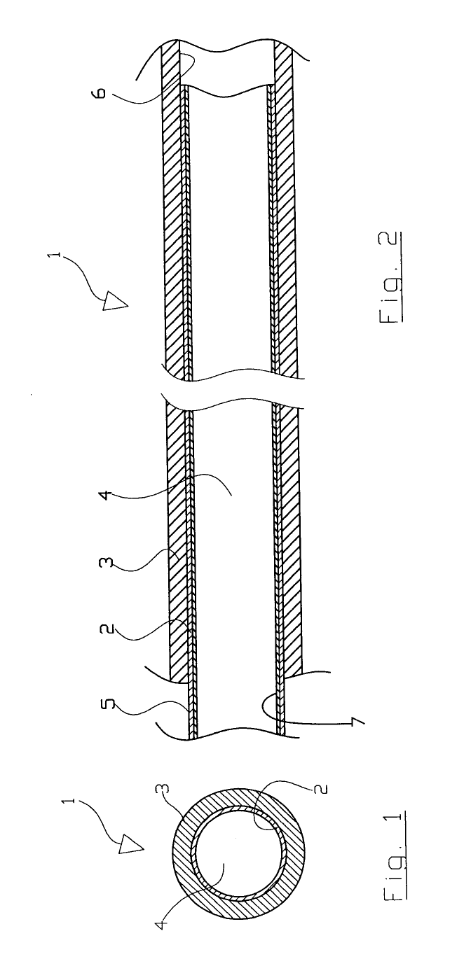

### DETAILED DESCRIPTION OF THE INVENTION

The fundamental principle of the invention is that the pressure measuring line consists of at least an inner hose and an outer hose enveloping the former, where the material of the inner hose is harder than that of the outer hose, and the thickness of the inner hose is smaller than that of the outer hose.

Due to the harder inner hose, in whose passageway the fluid is located, the pressure pulses are not biased or are biased only slightly. Due to the reduced elasticity of the inner hose, the resonance frequency of the transmission system is relatively high, so that the relevant frequency portions of the pressure pattern for the evaluation are below the resonance frequency, so that the system transmits the pressure pattern with more accuracy compared to the original. At the same time, damping is also sought and achieved, because the amplitudes above elevations in the area of resonance frequencies are damped. Due to the outer, softer hose, the flexibility of the pressure measuring line nevertheless is maintained, so that the hose can be placed and handled easily.

Therefore, the required resistance to kink formation is also ensured. The two hoses are firmly connected to each other over their entire surfaces. Here the inside of the outer hose is in contact with the outside of the inner hose over the entire surface. Advantageously, the two hoses are coextruded, so that the materials of the two hoses are mixed with each other in a transition area or layer.

According to a variant of the invention, the inner, harder hose can also have an inner layer made of a plastic softer than the material of the inner hose, which causes a controlled damping. This inner layer can be in the form of an additional hose, which is also in contact over the entire surface with the inner hose, and it can also be coextruded, for example, so that its material is mixed with that of the inner hose in a transition area or layer.

Depending on the desired damping behavior, the inner layer is either thicker or thinner than the inner hose.

The length of the pressure measuring line can be chosen as desired, where, naturally, one must take into consideration that the resonance frequency and the damping factor are functions of various parameters, one of which is indeed the length of the pressure measuring line. Other parameters are the diameter of the passageway, the material properties, particularly the modulus of elasticity and the hardness of the hoses, the wall thicknesses of the hoses and the placement shape of the pressure measuring line, where the latter should be positioned in as straight a line as possible and without sharp curvature radii, to prevent reflection of pressure waves.

In selecting the parameters and materials, one must ensure that the resonance frequency of the system is as high as possible, because otherwise it can lead to large measurement errors or incorrect interpretations of the signal, which in turn can lead to incorrect treatment of a patient. On the other hand, in the interest of user-friendliness and flexible placement of the pressure measuring line, one must also ensure sufficient flexibility.

The pressure measuring line is denoted as a whole with the reference numeral 1. It has at least one inner hose 2 and an outer hose 3 enveloping the former. The inner hose 2 forms a passageway 4, which, during the blood pressure measurement by a catheter—not shown—is connected to a blood vessel, such as, for example, an artery or vein of a patient, and its other end is connected to a pressure-measuring transducer.

The two hoses 2 and 3 are in contact over their entire surfaces, so that the outside 5 of the inner hose 2 is entirely in contact with the entire surface of the inside 6 of the outer hose 3. The inner hose 2 and the outer hose 3 are made of different materials, where the inner hose 2 is made of a harder material than the outer hose 3, so that the oscillation damping for pressure oscillations in the passageway 4 is largely eliminated. The materials of the inner hose 2 and of the outer hose 3 can become mixed in a transition area or layer, which is achieved in practice by coextruding the two hoses.

To adjust a predefined damping, the inner hose 2 can present on its inner wall a coating or layer 7 made of a material softer than the material of the inner hose 2. This layer 7 is also in contact with the inner hose over the entire surface and it can also be produced by a coextrusion, so that the material of the coating 7 becomes mixed with that of the inner hose 2 in a transition area or layer.

The wall thickness of the inner hose 2 is less than the wall thickness of the outer hose 3. The wall thickness of the optional coating 7 is less than that of the outer hose 3 and, depending on the damping behavior, smaller than, equal to or larger than that of the inner hose 2.

When choosing the materials and the dimensions one must ensure that the resonance frequency is as high as possible and that the damping is not too low, in order to allow the pressure and frequency range of interest to be optimally transmitted and to achieve as slight as possible biasing of the measurement result. On the other hand, one must also ensure that the line is sufficiently flexible to be handled with ease and to be led out of the patient to a pressure measuring transducer.

In a preferred presently known best embodiment the inner hose 2 of harder material is made of ethyl vinyl acetate (EVA) whereas the softer outer hose 3 is made of poly vinyl chloride (PVC). The inner coating 7 of the inner hose 2 is made of PVC, too.

The standard dimensions of pressure measuring lines for invasive blood pressure measurement are inner diameter 1.5 mm and outer diameter 3.0 mm for adults; and inner diameter 1.0 mm and outer diameter 2.0 mm for small children. Therefore, the wall thickness for the two or three walls is 0.75 mm for adults and 0.5 mm for children. In a preferred embodiment the inner hose 2 has a wall thickness of 0.2 mm, the outer hose a wall thickness of 0.45 mm, and the inner coating 7 a wall thickness of 0.1 mm for adults. In a preferred embodiment for children the inner hose wall thickness is 0.13 mm, the outer hose wall thickness is 0.3 mm, and the inner coating thickness is 0.07 mm. The damping factor in this embodiment is about 0.64 and the lowest resonance frequency is 26.4 Hz.

The above-mentioned materials and wall thicknesses are only examples and do not restrict the scope of the appended claims.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. A pressure measuring line for invasive blood pressure measurement comprising:
a wall made of a flexible material that surrounds a passageway, wherein the wall comprises at least one inner hose and an outer hose enveloping the inner hose, wherein the material of the inner hose is harder than the material of the outer hose, the wall thickness of the inner hose is less than the wall thickness of the outer hose, and the inner surface of the outer hose is in full-surface contact with the outer surface of the inner hose.

2. The pressure measuring line according to claim 1 wherein the materials of the inner hose and of the outer hose are mixed with each other in a transition area adjacent the outer surface of the inner hose and the inner surface of the outer hose.

3. The pressure measuring line according to claim 1 wherein the inner surface of the inner hose has a coating which is softer than the material of the inner hose.

4. The pressure measuring line according to claim 2 wherein the inner surface of the inner hose has a coating which is softer than the material of the inner hose.

5. The pressure measuring line according to claim 3 wherein the coating is thinner than the wall thickness of the outer hose.

6. The pressure measuring line according to claim 4 wherein the coating is thinner than the wall thickness of the outer hose.

7. The pressure measuring line according to claim 5 wherein the coating is thinner than the wall thickness of the inner hose.

8. The pressure measuring line according to claim 6 wherein the coating is thinner than the wall thickness of the inner hose.
